(19) United States
(12) Patent Application Publication
(10) Pub. No.: US 2007/0063832 A1
(43) Pub. Date: Mar. 22, 2007

(54) Method and apparatus for using a wireless controller in a wired security system

(76) Inventors: Jeffrey D. Ollis, Dresher, PA (US); John M. Coogan, Lansdale, PA (US); James A. Panacek, North Wales, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/228,171

(22) Filed: Sep. 16, 2005

(51) Int. Cl. G08B 29/00

(52) U.S. Cl. 340/510

(57) ABSTRACT

An apparatus for use in a wired security system includes a bridge. The bridge includes a network interface for receiving a wired status signal from at least one sensor employed in the wired security system and a first processor for converting the wired status signal to a wireless status signal in conformance with a prescribed protocol. A wireless transmitter is provided for transmitting the wireless status signal. The apparatus also includes a controller. The controller has a receiver for receiving the wireless status signal from the bridge a second processor for interpreting the status of the wireless status signal.

### FIELD OF THE INVENTION

The present invention generally relates to security systems that monitor conditions within a defined environment or area, and more particularly to a method and apparatus for using a wireless network controller in a wired security system.

### BACKGROUND OF THE INVENTION

Electronic security systems are becoming more common and important in residential and commercial environments. Individuals and families, in particular, desire a security system that monitors a defined premise and/or environment, to prevent or deter theft, burglary and robbery. In addition, there is a desire to monitor and detect other defined conditions and, in response to a detected condition, generate a warning. These other potentially hazardous conditions or threats include, for example, fire hazards, carbon monoxide and power failure and electricity outages.

A conventional security system for use in a home, for example, includes one or more keypads with displays and a central control panel, which in some cases is remotely located from the keypads and displays. A number of sensors are provided for detecting various conditions and are arranged in the home or premises. In legacy security systems, the sensors are most commonly connected to the control panel by wired means. The sensors may be of various types designed to detect a variety of conditions. The sensors are generally relatively simple devices having two operational states represented by a contact that is either in an open or closed state.

The keypad/display allows a user to control the system. The user can use the keypad/display to “arm” or “disarm” the system in addition to selecting amongst the sensors to control. In the event of a false alarm, the homeowner may use the keypad to reset the alarm. The typical control panel includes a central microprocessor or an equivalent, which receives messages from the sensors including, for example, motion sensors, infrared sensors, magnetic or glass break sensors, fire sensors and carbon monoxide sensors. These messages generally indicate which of the two states the sensors are in. If the system is “armed” and one or more sensor is triggered, a signal is generated and received by the control panel. The control panel circuitry activates a built-in telephone communicator to contact the proper authority, for example law enforcement, firefighting and/or health professionals, and conveys, for example, a pre-recorded message providing relevant information related to the triggered sensor. Alternatively, the telephone communicator may contact a security company monitoring the system, for example ADT, and provide information about the event which triggered the alarm condition. The security company, in turn, relays the information to the proper authority.

Recently in part to reduce the labor costs of installing wired systems into existing homes, wireless security systems have been developed. These systems use RF communications for at least some of the keypads and sensors. The functionality of wireless security systems and legacy wired systems are largely similar, except that a wireless central control panel, a wireless central transmitter, and wireless remote sensors are substituted for their wired counterparts. Wireless systems, however, often offer enhanced functionality over what is available from wired systems. For example, the sensors in wireless systems can be more sophisticated than the simple open or closed contacts often used in legacy wired systems (monitoring and status applications). Additionally, while legacy wired systems generally involve only one way communication between the sensors and the control panel, wireless security systems often employ bidirectional communication between the sensors and the control panel. Accordingly, residents and other users of legacy wired security systems have a number of reasons for desiring to upgrade their systems to a wireless system.

One impediment to upgrading that arises is that users are not inclined to outright replace their wired security systems with a wireless security system, given the relatively significant investment they have made in their legacy security systems. Because of the relatively large number of legacy wired security systems currently in use, there is a significant need to provide a method and apparatus for incrementally upgrading a legacy wired communication system with a wireless communication system without completely replacing it.

### BRIEF DESCRIPTION OF THE DRAWINGS

FIG. 1 illustrates a typical legacy wired security system.

FIG. 2 shows a block diagram of an exemplary wireless network controller of the type employed in a wireless security system.

FIG. 3 shows an exemplary ZigBee-enabled transceiver that may be employed in the wireless controller of FIG. 2.

FIG. 4 shows a bridge that may be used with the wireless controller of FIG. 3 in a wired security system.

FIG. 5 shows a wired security system in which the wired controller has been replaced by the wireless controller of FIG. 3 and the bridge of FIG. 4.

### DETAILED DESCRIPTION

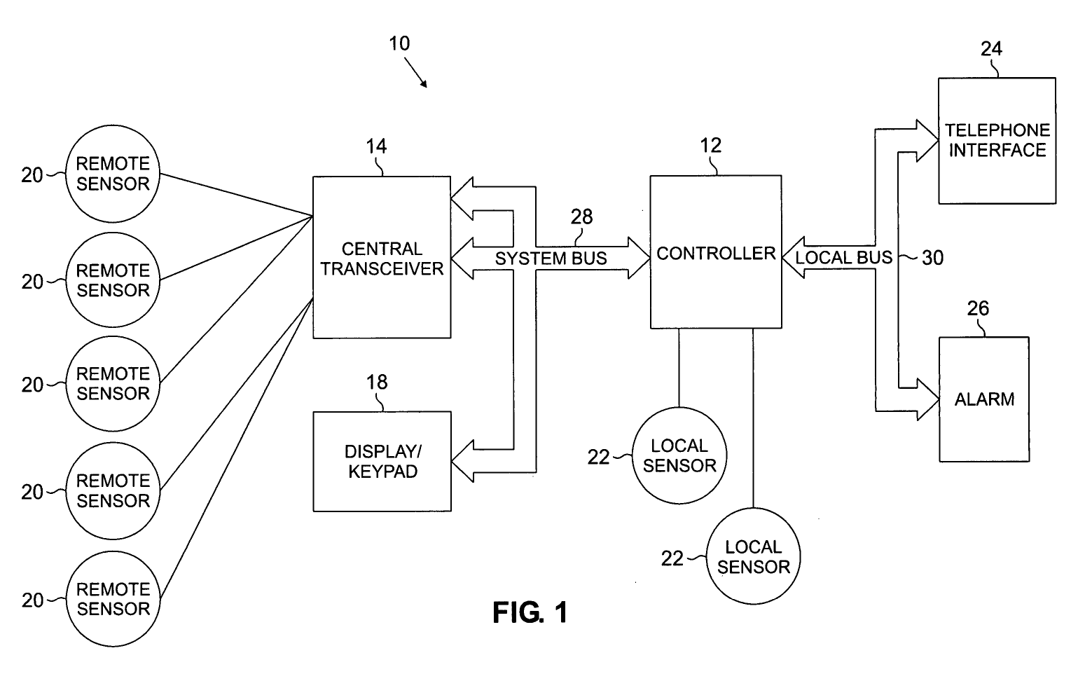

FIG. 1 illustrates a typical legacy wired security system 10. The wired security system 10 comprises a central control unit 12, a central transceiver 14 (which is some cases is incorporated in the central control unit 12), a console display/keypad 18, a plurality of remote sensors 20 and local sensors 22, a telephone dialer 24 and an alarm 26. The remote sensors 20 are hard-wired to the central transceiver 14, which communicates with the central control unit 12 via a system bus 28. The system bus 28 also links the central control unit 12 to the console display/keypad 18. System bus 28, as well as the hard wired connections between the sensors 20 and the central transceiver 14, are often simply a twisted pair conductor. Of course, the buses and other connections may have conductor configurations other than a twisted pair configuration. The central control unit 12 is connected to the telephone interface 24 (e.g., an autodialer) and the alarm 26 via an auxiliary local bus 30. The central control unit 12 is also hardwired to the local sensors 22. Despite the availability of wireless capabilities (i.e., wireless communication between components, especially between the remote sensors 20 and the central control unit 12), this type of wired security system 10 still prevails in many commercial and residential applications.

Currently available wireless security systems use any of a variety of different communication standards. For example, such systems may use, without limitation, IEEE 802.11 (e.g., 802.11a; 802.11b; 802.11g), IEEE 802.15 (e.g., 802.15.1; 802.15.3, 802.15.4), DECT, PWT, pager, PCS, Wi-Fi, Bluetooth™, cellular, and the like. While the wireless security systems, and hence wireless controllers employed in such systems, may encompass any of these standards, one particularly advantageous network protocol that is currently growing in use is ZigBee™, which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security. For these reasons ZigBee may be particularly appropriate for use in wireless security systems.

ZigBee-compliant products operate in unlicensed bands worldwide, including 2.4 GHz (global), 902 to 928 MHz (Americas), and 868 MHz (Europe). Raw data throughput rates of 250 Kbps can be achieved at 2.4 GHz (16 channels), 40 Kbps at 915 MHz (10 channels), and 20 Kbps at 868MHz (1 channel). The transmission distance generally ranges from 10 to 75 m, depending on power output and environmental characteristics. Like Wi-Fi, Zigbee uses direct-sequence spread spectrum in the 2.4 GHz band, with offset-quadrature phase-shift keying modulation. Channel width is 2 MHz with a 5 MHz channel spacing. The 868 and 900 MHz bands also use direct-sequence spread spectrum but with binary-phase-shift keying modulation.

The IEEE 802.15.4 specification defines four basic frame types: data, acknowledgement (ACK), MAC command and beacon. The data frame provides payloads of up to 104 bytes. The ACK frame provides feedback from the receiver to the sender confirming that the packet was received without error. The MAC command frame provides the mechanism for remote control and configuration of the network devices. The centralized network controller uses MAC to configure individual network device's command frames no matter how large the network. Finally, the beacon frame wakes up client devices, which listen for their address and go back to sleep if they don't receive it.

ZigBee networks can use beacon or non-beacon environments. Beacons are used to synchronize the network devices, identify the network, and describe the structure of the superframe. The beacon intervals are set by the network controller and can vary from 15 ms to over 4 minutes. Sixteen equal time slots are allocated between beacons for message delivery. The channel access in each time slot is contention-based. However, the network coordinator can dedicate up to seven guaranteed time slots for noncontention based or low-latency delivery.

The non-beacon mode is a simple, traditional multiple-access system of the type used in simple peer and near-peer networks. It operates like a two-way radio network, where each device is autonomous and can initiate a conversation at will, but could interfere with others unintentionally. The recipient may not hear the call or the channel might already be in use. Beacon mode is a mechanism for controlling power consumption in extended networks such as cluster tree or mesh. It enables all the devices to know when to communicate with each other. In ZigBee, the two-way radio network has a central dispatcher that manages the channel and arranges the calls. A primary value of beacon mode is that it reduces the system's power consumption.

As previously mentioned, for a number of reasons it may be desirable to upgrade a legacy wired security system with wireless components. For example, the wired controller in a legacy system may fail and need replacing. More and more the availability of wireless controllers is increasing while the availability of legacy wired controllers is presumably decreasing. In addition, wireless sensors are often available that may operate in more than two states (e.g., open and closed). For instance, condition monitor sensors that may be desirable for use in a residence include temperature, moisture, power level and energy usage (e.g., natural gas, electricity). These sensors preferably provide information that cannot be readily embodied in two states, but rather provide information that can be in a continuum of states. Legacy wired security systems generally do not have the capability to perform such monitoring. Accordingly, the addition of wireless sensors to a legacy security system can provide enhanced monitoring functionality that is not otherwise available.

While a legacy security system in effect can be upgraded by the addition a separate wireless system to the premises that operate in parallel and independently of one another, it will often be preferable to have a single integrated system rather than two separate systems that each employ their own controllers. This can be most simply accomplished by replacing the wired controller in the legacy system with a wireless controller. As detailed below, in accordance with the present invention, a wired controller can be replaced with a wireless controller with the addition of a bridge or converter for transforming the signals from the wired legacy sensors to a wireless signal that conforms to the standards or protocols employed by the wireless controller.

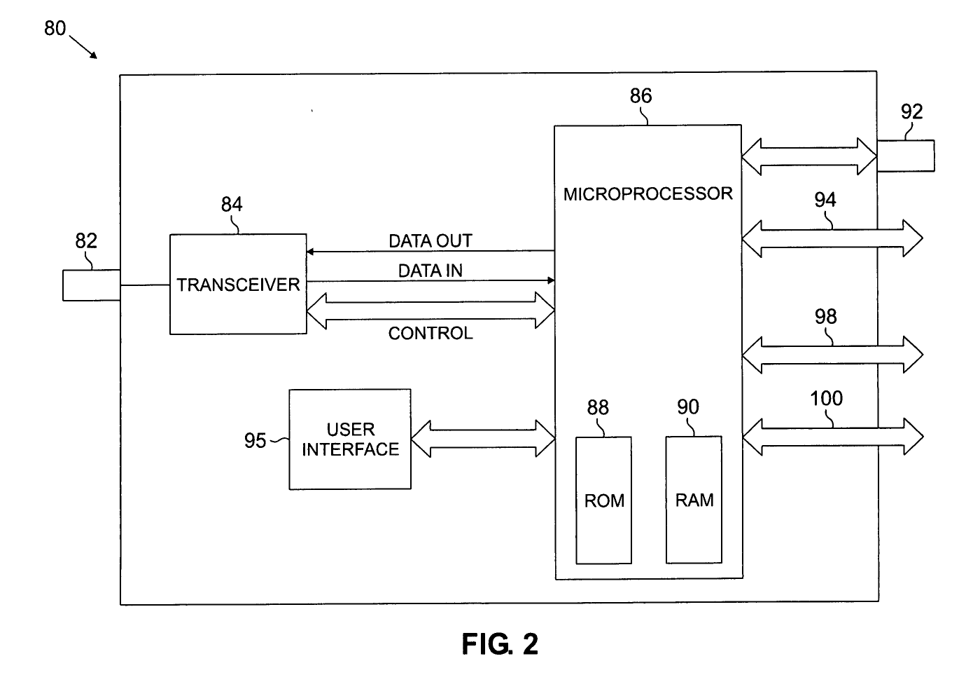

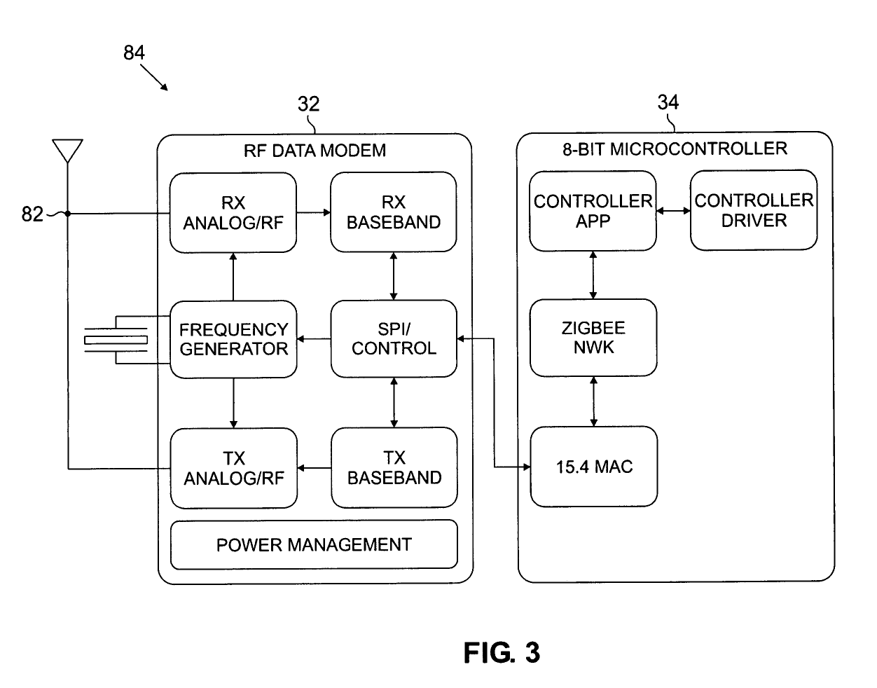

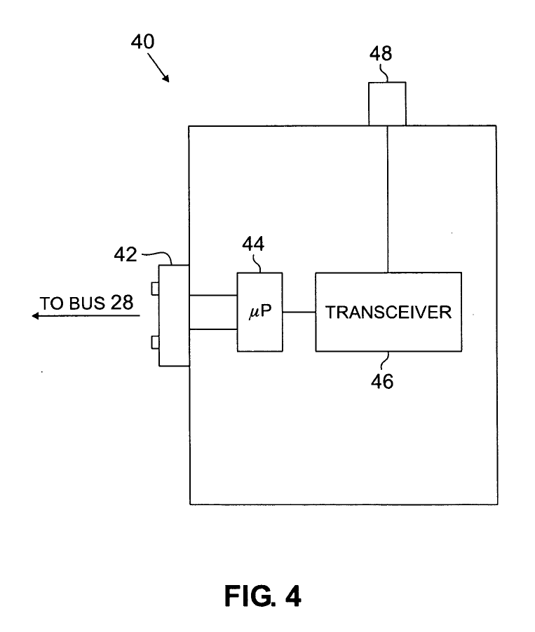

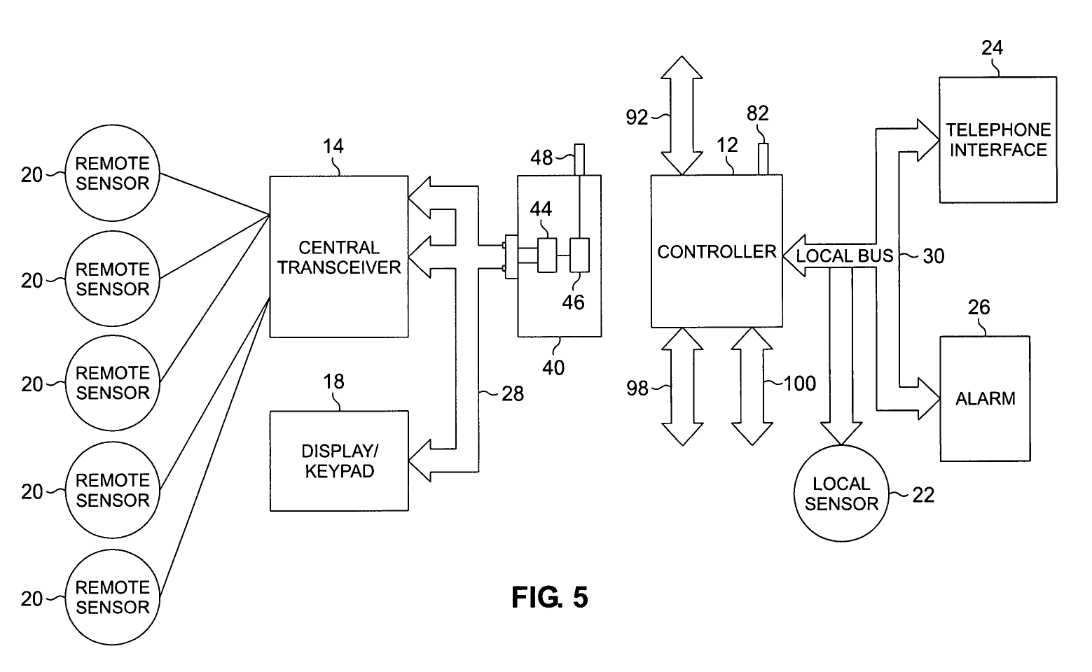

FIG. 2 shows a block diagram of an exemplary wireless network controller 80 of the type employed in a wireless security system. The wireless network controller 80 can be used to replace the wired network controller 12 employed in the security system shown in FIG. 1 with the addition of a bridge 40, discussed below in connection with FIGS. 4 and 5. The network controller 80 includes an antenna port 82, RF front-end transceiver 84, microprocessor 86 having ROM 88 and RAM 90, programming port 92, and local bus 94 (corresponding to local bus 30 in FIG. 1). Local bus 94 may also be used to communicate with any local sensors (e.g., local sensors 22 in FIG. 1) that may be employed. If the network controller 80 is ZigBee compliant, front end transceiver 84 may be of the type depicted in FIG. 3 by analog portion 32 and digital portion 34. If employed, local bus 94 may include, for example, one or more analog-to-digital inputs, one or more digital-to-analog outputs, one or more UART ports, one or more Serial Peripheral Interface (SPI) and/or one or more digital I/O lines (not shown). The network controller may also include RAM port 98 and ROM port 100 for, among other things, upgrading software residing in the microprocessor 86. User interface 95 (e.g., a keypad/display unit) allows control of the various user-adjustable parameters of the network controller 80.

FIG. 3 shows in more detail an exemplary ZigBee-enabled transceiver 84 that may be employed in the wireless controller 80. The transceiver 84 includes an analog portion 32 (e.g., a radio frequency integrated circuit) that has a partially implemented PHY layer. The analog portion is connected to a digital portion 34 (e.g., a low-power, low-voltage 8-bit microcontroller) with peripherals, which in turn is connected to processor 86 of controller 80. The protocol stack and application firmware generally reside in a memory such an on-chip flash memory. The analog part of the receiver converts the desired signal from RF to the digital baseband. Synchonization, despreading and demodulation are performed in the digital part of the receiver. The digital part of the transmitter does the spreading and baseband filtering, whereas the analog part of the transmitter does the modulation and conversion to RF. ZigBee enabled transceivers 84 of the type depicted in FIG. 3 are commercially available from a number of vendors, including, for example, Motorola.

In accordance with the present invention, the wired controller in a legacy wired security system may be replaced by a wireless network controller of the type depicted in FIG. 2 with use of a bridge, one embodiment of which is shown in FIG. 4. The bridge 40 includes a bus interface 42, processor 44, wireless transceiver 46 and antenna port 48. The bus interface 42 is provided to communicate with the bus 28 from the central transceiver 14 (or directly from the remote sensors 20 if transceiver 14 is not employed). If the bus 28 is a twisted pair conductor, bus interface 42 may be simply a pair of contacts for receiving the twisted pair. The bus interface 42 forwards the signals received from the transceiver 14 to the processor 44. Depending on the capabilities of the wired network, the bus interface 42 may be configured for one way or bidirectional communication. Processor 44 translates the signal, which as previously mentioned is typically only a two-state signal, into a message format compatible with the wireless protocol that is employed by the wireless controller. For example, assuming the wireless controller is ZigBee compliant, the processor 44 translates the signal into a ZigBee message by inserting the information into a ZigBee data packet. Tranceiver 46 receives the message from processor 44 and then wirelessly transmits it to the wireless controller 80 (see FIG. 5 in which the wired controller 12 has been replaced by the wireless controller 80 of FIG. 3 and the bridge 40 of FIG. 4). If the wired security system is provisioned for bidirectional communication between the sensors and the controller, bridge 40 also receives wireless messages from the wireless controller 80, translates the message into the appropriate wired format, and forwards the signal to the appropriate sensor(s) via bus interface 42 and bus 28.

The translation process performed by the bridge 40 in converting the wired signal to a wireless signal may be accomplished in a variety of different ways. For example, the bridge 40 may have a database or lookup table (located, for example in a ROM associated with processor 44) that lists various wired signal message formats and the corresponding wireless signal message formats that are recognized by the wireless controller 80). Such a table may be provided for different manufacturers of the sensors in the legacy wired security system since presumably each manufacturer may have its own message format. The database may be incorporated into the bridge 40 at the time of purchase or it may be installed (if embodied in hardware) or downloaded (if embodied in software) by a technician at the time of installation, who can then download the correct table for the particular legacy system that is already in place. In some cases the bridge 40 will recognize the message format received from the wireless sensors and automatically select the correct table to use, thus avoiding the need for any manual provisioning at the time of installation.

As shown in FIG. 5, a wireless network bridge is conveniently formed between the wired legacy system and the wireless network controller. Not only does this allow replacement of a legacy wired controller with a readily available wireless controller, it also allows the system to be further upgraded with the addition of wireless sensors, which may be more complex than the simple two state sensors often employed in legacy security systems.

It will be understood that the particular functional elements set forth in the figures above are shown for purposes of clarity only and do not necessarily correspond to discrete physical elements. Moreover, the various functional elements may be performed in hardware, software, firmware, or any combination thereof.

1. An apparatus for use in a wired security system, comprising:
a bridge, said bridge including:
a network interface for receiving a wired status signal from at least one sensor employed in the wired security system;
a first processor for converting the wired status signal to a wireless status signal in conformance with a prescribed protocol;
a wireless transmitter for transmitting the wireless status signal;
a controller, said controller including:
a receiver for receiving the wireless status signal from the bridge; and
a second processor for interpreting the status of the wireless status signal.

2. The apparatus of claim 1 further comprising a wired security sensor coupled to the network interface of the bridge.

3. The apparatus of claim 1 wherein the bridge includes a database relating wired status signal formats and wireless status signal formats.

4. The apparatus of claim 1 wherein the wireless transmitter and the wireless receiver are ZigBee compliant.

5. The apparatus of claim 3 wherein the database is stored in ROM.

6. The apparatus of claim 1 wherein said controller is a wireless controller.

7. A method for receiving a wired status signal from a wired security system, comprising:
receiving a wired status signal from a wired security system;
converting the wired status signal to a wireless status signal; and
transmitting the wireless status signal to a network controller.

8. The method of claim 7 wherein the converting step includes the step of accessing a database relating wired status signal formats to a wireless status signal format.

9. The method of claim 7 further comprising the step of replacing a wired controller employed in the wired security system with a wireless control apparatus.

10. The method of claim 8 wherein said wireless control apparatus includes a wireless controller and a bridge.

11. The method of claim 10 wherein the receiving, converting and transmitting steps are performed by the bridge.

12. The method of claim 7 wherein the wireless status signal is ZigBee compliant.

13. The method of claim 7 wherein said network controller is a wireless network controller.

14. At least one computer-readable medium encoded with instructions which, when executed by a processor, perform a method including the steps of:
receiving a wired status signal from a wired security system;
converting the wired status signal to a wireless status signal; and
transmitting the wireless status signal to a wireless network controller.

15. The computer-readable medium of claim 14 wherein the converting step includes the step of accessing a database relating wired status signal formats to a wireless status signal format.

16. The computer-readable medium of claim 14 wherein the wireless status signal is ZigBee compliant.
